(19) United States
(12) Patent Application Publication
(10) Pub. No.: US 2024/0311184 A1
(43) Pub. Date: Sep. 19, 2024

(54) MULTIPLE WORK COMPLETION MESSAGES FOR WORK DESCRIPTORS

(71) Applicant: Mellanox Technologies, Ltd., Yokneam (IL)

(72) Inventors: Natan Manevich, Nesher (IL); Wojciech Wasko, Mlynek (PL); Dotan David Levi, Kiryat Motzkin (IL); Ariel Shahar, Jerusalem (IL); Roee Moyal, Yoqneam Ilit (IL); Eliel Peretz, Kiryat Motzkin (IL)

(21) Appl. No.: 18/495,749

(22) Filed: Oct. 26, 2023

Related U.S. Application Data
(60) Provisional application No. 63/587,431, filed on Oct. 2, 2023.
(60) Provisional application No. 63/451,902, filed on Mar. 13, 2023.

(51) Int. Cl. G06F 9/48; G06F 11/34

(52) U.S. Cl. CPC G06F 9/4881; G06F 11/3409

(57) ABSTRACT

A work descriptor identifying a plurality of workflow tasks to be performed by a hardware device is generated by a host system. The work descriptor corresponds to a performance completion message generated by the hardware device in response to completing performance of the work descriptor. One or more completion indicators are added to the work descriptor. Each of the completion indicators instructs the hardware device to generate one or more additional completion messages during performance of the work descriptor in response to a trigger criterion. The work descriptor is caused to be available to the hardware device for execution.

### RELATED APPLICATIONS

This application claims the benefit of U.S. Provisional Patent Application No. 63/451,902, filed Mar. 13, 2023, and U.S. Provisional Patent Application No. 63/587,431, filed Oct. 2, 2023, all of which are incorporated by reference herein in their entirety.

### TECHNICAL FIELD

Aspects and implementations of the present disclosure relate to systems and hardware devices using work descriptors, and in particular to multiple completion messages for work descriptors.

### BACKGROUND

Within computing devices, networking devices, and other hardware devices, exposure of internal hardware information, diagnostics, and statistics remains a challenge in the hardware industry. Such information is employed to understand the internal behavior and processes running on the hardware and provides valuable information that may be utilized to debug and stabilize hardware performance. Several approaches to exposing internal diagnostics and statistics exist, such as event logging techniques. Event logging techniques generally allow configuration of targeted events to be captured using filtering options (e.g., filtering profiles), but these configurations may not be granular enough to target a subset of workloads triggering the targeted events.

### BRIEF DESCRIPTION OF DRAWINGS

Various embodiments in accordance with the present disclosure will be described with reference to the drawings, in which:

FIG. 1A is a block diagram illustrating a system comprising a host and a hardware device, according to at least one embodiment.

FIG. 1B is a block diagram illustrating a system comprising a plurality of hosts and a hardware device, according to at least one embodiment.

FIG. 2A illustrates an example multiple-completion work descriptor used for hardware event logging, according to at least one embodiment.

FIG. 2B illustrates an example multiple-completion work descriptor used for hardware event logging, according to at least one embodiment.

FIG. 2C illustrates an example multiple-completion work descriptor used for hardware event logging, according to at least one embodiment.

FIG. 3A illustrates an example additional completion message generated in response to a hardware trigger, according to at least one embodiment.

FIG. 3B illustrates an example additional completion message generated in response to a hardware trigger, according to at least one embodiment.

FIG. 4 is a flow diagram of a method for providing additional completion messages in response to hardware triggers using multiple-completion work descriptors, according to at least one embodiment.

FIG. 5 is a flow diagram of a method for providing additional completion messages in response to hardware triggers using multiple-completion work descriptors, according to at least one embodiment.

FIG. 6 is a block diagram illustrating a computer system, according to at least one embodiment.

### DETAILED DESCRIPTION

Aspects of the present disclosure relate to multiple work completion messages for work descriptors. Hardware devices are being designed for and tasked with processing increasingly large amounts of data while minimizing resource consumption (e.g., power, bandwidth, storage, physical footprint, cost, etc.). A hardware device may be, for example, a network interface controller (NIC), a graphics processing unit (GPU), a data processing unit (DPU), or a central processing unit (CPU). Such hardware devices are used in various domains including networking, cloud computing, artificial intelligence (AI) and machine learning (ML), edge computing, and consumer electronics, to name a few. One technique for controlling hardware devices is to provide a work descriptor to the hardware device (e.g., from a host device) describing the data to process and operations to perform on the data. A work descriptor may refer to a construct (e.g., a data structure) that follows a predefined format and enables the host system and the hardware device to communicate with each other. Each work descriptor may specify one or more tasks (e.g., workflow task(s)) to be executed by the hardware device. A hardware device may send a performance completion message to the host once a work descriptor has been fully executed.

Hardware devices may be associated with various operational statistics and diagnostic information. Such information is crucial for developers and operators/administrators of hardware systems because the information can be used to achieve highly optimized and efficient solutions, to detect and avoid bottlenecks, to efficiently debug under-performing systems, and for other development and operational purposes. An operational statistic may be any measurement or unit of information that is relevant to the functioning or performance of the hardware device or a component of the hardware device. For example, a hardware device's clock speed, power consumption, allocated/used memory, and similar information may be operational statistics. Other examples of useful diagnostic information and operation statistics include the rate at which the hardware device or a component thereof is processing data (e.g., network packet send rate), various latencies and time measurements, errors representing unexpected or problematic conditions on the hardware device, breakpoints for debugging purposes, etc.

In conventional systems, various techniques are used to expose internal diagnostics and operational statistics in hardware devices for debugging and operational purposes. Event logging is one such technique. A typical example of event logging may involve using a log (e.g., a file) to record diagnostic data related to various events that occur in a hardware system. For example, in the case of packets sent on a network port, the diagnostic data may include port number, packet length, packet priority, work queue of the packet, transmission time, and the like. Event logging techniques generally allow configuration of targeted events to be captured using filtering options (e.g., filtering profiles), but these configurations may not be granular enough to target a subset of workloads triggering the targeted events. Thus, event logging often results in the capture of all events that meet a specific filtering profile for all workloads, and an excessive number of irrelevant events may overwhelm the system, consume too much bandwidth or storage, or make the task of manually sorting through logs exceedingly difficult. Accordingly, processing of all the events provided by a specific filtering profile in real-time becomes unfeasible. Furthermore, event logging techniques may rely on external tools and processes, such as external debuggers, to log events that occur in the operating system, software, and/or hardware systems. Reliance on these external tools and processes limit the ability of a system to decide in real-time (e.g., “on demand”) whether to log an event, and can be the source of unnecessary integration challenges for system architects and engineers. For example, in order to initiate event logging, a system may have to stop sending new work to the target and request an external tool to enable event logging. The system may have to wait for confirmation from the external tool that event logging is enabled before resuming sending new work to the target. This process can introduce excessive latency in the normal workflow.

Similar challenges may impact conventional systems in an operational or production environment. System engineers may wish to receive performance data (e.g., on a periodic basis) reflecting how the hardware device is performing under present operational conditions. External tools such as the debuggers mentioned previously may be inappropriate to deploy in a production environment to monitor operation of hardware devices because the overhead associated with the debugger (e.g., increased latency, interruption to normal workflow) can reduce efficiency of the system. Furthermore, the lack of sufficiently granular logging infrastructure as previously described may lead to continuous logging of irrelevant events in production, consuming vital resources (e.g., bandwidth, storage) unnecessarily. As a result of these challenges, conventional systems may operate with lower capacity and efficiency while consuming excess resources such as storage, power, and bandwidth. These factors may lead to increased operational costs for owners and administrators of conventional systems.

Aspects of the present disclosure address the above and other deficiencies by providing multiple completion messages for work descriptors. Host systems and hardware devices utilizing the techniques described herein may include multiple-completion work descriptors for indicating to the hardware device that additional work completion messages should be generated in association with the execution of the work descriptor. Systems utilizing these techniques may further include additional work completion messages comprising various unique identifiers and payloads of diagnostic information generated by the hardware device as indicated by the multiple-completion work descriptors.

In at least one embodiment, multiple-completion work descriptors are provided. A work descriptor may initially specify tasks of a certain type (e.g., workflow tasks) to be performed by a hardware device. The work descriptor may be modified to further specify one or more completion indicators, which may instruct the hardware device to generate one or more additional completion messages comprising specific payloads of operational statistics and other data. Thus, a multiple-completion work descriptor may be a wrapper around a conventional work descriptor, providing the advantage that the hardware device can reuse existing logic to decode the conventional work descriptor within in the multiple-completion work descriptor. Another advantage is that multiple-completion work descriptors can be selectively generated and applied to a subset of conventional work descriptors in a debug or operational/production environment to provide specific and granular diagnostic information when it is needed, minimizing the bandwidth and storage consumed by unneeded diagnostic information. The completion indicators of the multiple-completion work descriptor may be bitfields or other types of fields and may specify trigger criteria for generate additional completion messages. Various types of multiple-completion work descriptors besides the wrapper-type work descriptors may be used as well.

In at least one embodiment, additional completion messages and formats thereof are provided. Additional completion messages may be generated by a hardware device in response to various triggers indicated in a multiple-completion work descriptor. The generated additional completion messages may be sent (e.g., individually or in groups) to the host system that provided the work descriptor or to other hosts or devices as indicated in the multiple-completion work descriptor. An additional completion message may include one or more unique identifiers that associate the message with particular work descriptors, workflow tasks, hardware events, trigger criteria, etc. An additional completion message may further include one or more payloads comprising diagnostic information and operational statistics such as timestamps, latency statistics, utilization statistics, etc.

Accordingly, aspects and embodiments of the present disclosure enable diagnostic- and debug-related indicators to be added to select work descriptors “on the fly,” which instruct a hardware device to generate multiple work completion messages for each work descriptor. As a result, users (e.g., software/hardware developers, system administrators) no longer need to rely on external tools and processes such as third-party event logger software to inspect internal hardware information and work descriptor diagnostics, which can reduce the amount of time needed for system configuration and improve system performance and latency. Furthermore, systems no longer need to maintain large stores of irrelevant logs and users no longer need to craft filters or manually sort through large collections of logs to find relevant information related to specific work descriptors. Accordingly, fewer computing and storage resources are used for gathering and storing logs, which in turn can improve system latency and resource (e.g., power) consumption and reduce operating costs of these systems.

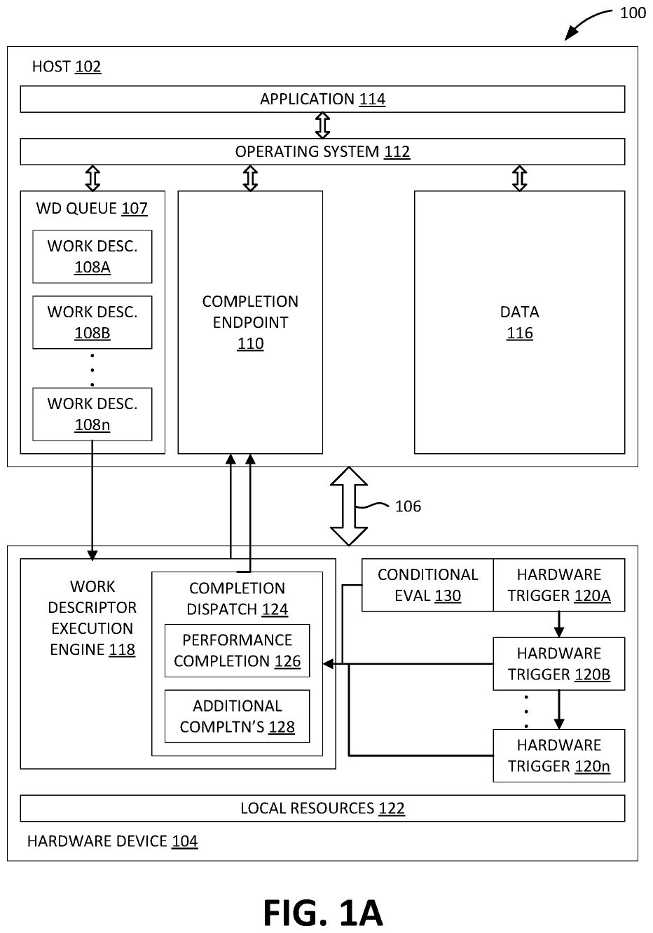

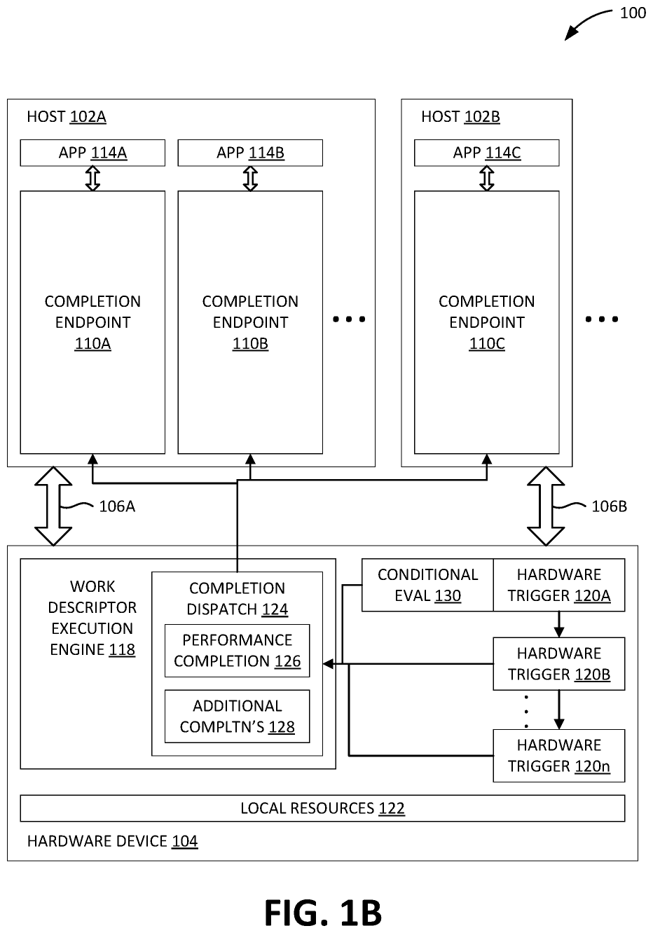

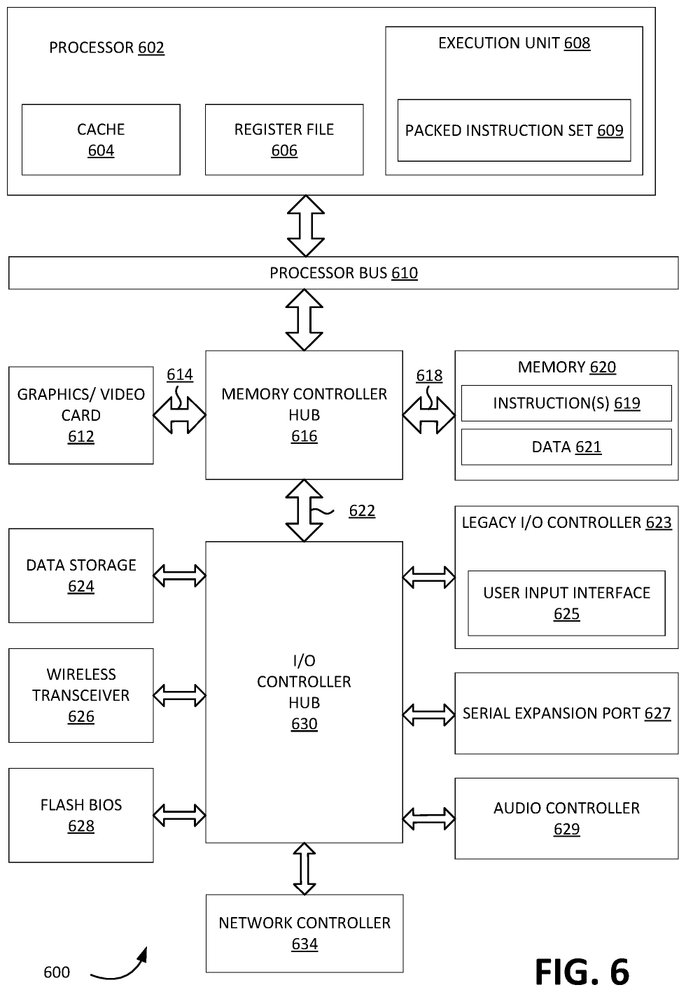

FIG. 1A illustrates a system 100 comprising a host 102 and a hardware device 104 in accordance with at least one embodiment. In at least one embodiment, host 102 is a computer system and may comprise a central processing unit (CPU), random-access memory (RAM), data storage, input/output peripherals, and other components. An example computer system is described in further detail with respect to FIG. 6. Hardware device 104 may be another computer system, a central processing unit, a graphics processing unit (GPU), a data processing unit (DPU), a network interface controller (NIC), or other peripheral. Host 102 and hardware device 104 are connected by communication channel 106. Communication channel 106 may comprise any networking, switching, or other communication protocols and buses alone or in combination, such as PCle, NVIDIA NVLINK, InfiniBand, Ethernet, Fibre Channel, a cellular or wireless communication network, a ground referenced signaling (GRS) link, the Internet, combinations thereof (e.g., Fibre Channel over Ethernet), or variants thereof, for example.

In at least one embodiment, system 100 corresponds to one or more of a personal computer (PC), a laptop, a workstation, a tablet, a smartphone, a server, a collection of servers, a data center, or the like. In at least one embodiment, host 102 and hardware device 104 are discrete components that comprise system 100. In at least one embodiment, host 102, hardware device 104, and communication channel 106 are part of a monolithic system 100, such as a system-on-chip (SoC).

In at least one embodiment, host 102 comprises a work descriptor queue 107 of work descriptors 108A-n and a completion endpoint 110. Host 102 may further comprise an operating system (OS) 112, an application 114, and data 116 associated with application 114. OS 112 may mediate between application 114 and any of hardware device 104, work descriptor queue 107, completion endpoint 110, or data 116. OS mediation may be accomplished via drivers, libraries, kernel modules, application programming interfaces (APIs), or similar. In at least one embodiment, OS 112 may be absent and the application may directly communicate with any of hardware device 104, work descriptor queue 107, completion endpoint 110, or data 116 without OS mediation. In at least one embodiment, host 102 and application 114 are synonymous (e.g., an application container), and application 114 manages work descriptor queue 107, completion endpoint 110, and data 116, as well as communication with hardware device 104. In at least one embodiment, OS 112 and application 114 are synonymous (e.g., a kernel module or driver is the application). In at least one embodiment, host 102 may comprise additional work completion endpoints 110 (e.g., as described below with respect to FIG. 1B), which may each be associated with one or more applications 114, one or more kernel modules or drivers, or other aspects of host 102. Various embodiments may utilize any combination of the above host architectures and communication methods.

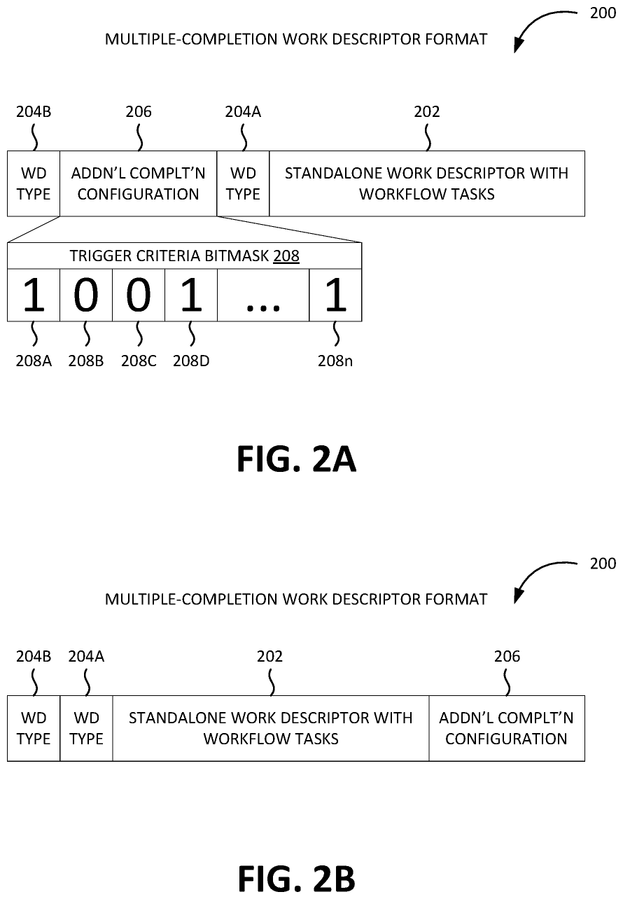

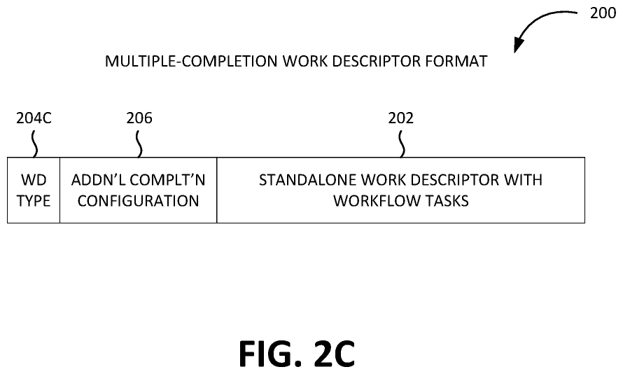

Work descriptor queue 107 may be a section of memory, a buffer, a file, or other storage solution for maintaining a queue of work descriptors. Work descriptors 108A-n may be constructs that specify one or more workflow tasks to be completed by hardware device 104. Each work descriptor 108A-n may further correspond to a performance completion message generated by the hardware device in response to completing performance of the work descriptor. Work descriptor queue 107 may hold a mix of standalone work descriptors and multiple-completion work descriptors, examples of which are further described with respect to FIGS. 2A-C. In at least one embodiment, work descriptor queue 107 is loaded with new work descriptors by OS 112 or application 114, and work descriptors are unloaded from work descriptor queue 107 by hardware device 104. In at least one embodiment, work descriptor queue 107 is unloaded by the host and the work descriptors are sent to hardware device 104. In at least one embodiment, multiple work descriptors queues 107 may be present on host 102 (e.g., each corresponding to a different application or driver) and may be serviced by one or more hardware devices 104.

Completion endpoint 110 may enable communication from hardware device 104 to host 102 regarding work descriptors issued from work descriptor queue 107. Completion endpoint 110 may be a return value from a function or API, a synchronous or asynchronous callback, a message-passing system (e.g., pipes, FIFOs, or similar inter-process communication), a block or character device, a hardware interrupt, a section of shared memory or memory-mapped I/O (e.g., observed by host 102 via polling, interrupt, or direct memory access), or similar technique. Completion endpoint 110 may also receive communications from hardware device 104 related to multiple-completion work descriptors in at least one embodiment.

In at least one embodiment, hardware device 104 comprises a work descriptor execution engine 118, one or more hardware triggers 120A-n, and local resources 122. Work descriptor execution engine 118 may be implemented as a processor, a state machine, software, or any other implementation capable of performing the functions described herein. In at least one embodiment, work descriptor execution engine 118 fetches or receives a new work descriptor from host 102, such as from work descriptor queue 107. Work descriptor execution engine 118 can decode the work descriptor to determine one or more workflow tasks to execute (an example format of a work descriptor is described in more detail with respect to FIGS. 2A-C). Work descriptor execution engine 118 may further include completion dispatch 124 to send completion messages to one or more completion endpoints (e.g., completion endpoint 110) on host 102 or other devices connected to hardware device 104. At the completion of the workflow tasks (e.g., all workflow tasks) associated with the work descriptor, work descriptor execution engine 118 may send performance completion message 126, including returning any results associated with the work descriptor or task(s) if applicable. In some embodiments, work descriptor execution engine 118 may send one or more additional completion messages 128 associated with the work descriptor, such as completion messages related to hardware triggers 120A-n. Additional completion messages 128 may be sent before or after performance completion message 126 for each work descriptor.

For each workflow task, the work descriptor execution engine can initiate one or more hardware events to perform the workflow task. Not all hardware events may be relevant to each workflow task, and thus a limited subset of hardware events may be active for a given workflow task. Some workflow tasks may utilize a subset of hardware events multiple times, such as in a looping or recursive workflow task. Each hardware event may comprise dedicated logic or resources, such as a local processor, memory, state machine, or software, for example. Hardware events may also be associated with one or more local resources 122. Local resources 122 may include additional processors or memory, input/output peripherals (e.g., network interface or graphical output), or other dedicated hardware (e.g., encoders/decoders, CRC checker). Local resources 122 may also provide hardware events with access to the host via communication channel 106. For example, a hardware event may involve fetching data from data 116, which may be mediated by OS 112 or application 114, or which may be accomplished via direct memory access (DMA) or similar techniques.

Hardware events may be associated with one or more hardware triggers 120A-n, which may correspond to an initiation, progress status, error status, or completion of a hardware event. Hardware triggers may be associated with a breakpoint at a hardware event and thus act as a debugging tool or assist an external debugging tool. Hardware triggers 120A-n may similarly be associated with a progress status of one or more local resources 122 (e.g., initiate, complete, early-stop, error). In at least one embodiment, each local resource is associated with a single hardware trigger (e.g., a CRC checker resource may be associated with an CRC hardware trigger and not other hardware triggers). In at least one embodiment, a local resource may be associated with multiple hardware triggers (e.g., a network interface resource may be associated with a packet-received hardware trigger and a packet-sent hardware trigger, or communication channel 106 may be associated with an initiate-data-fetch hardware trigger and a data-fetch-complete hardware trigger).

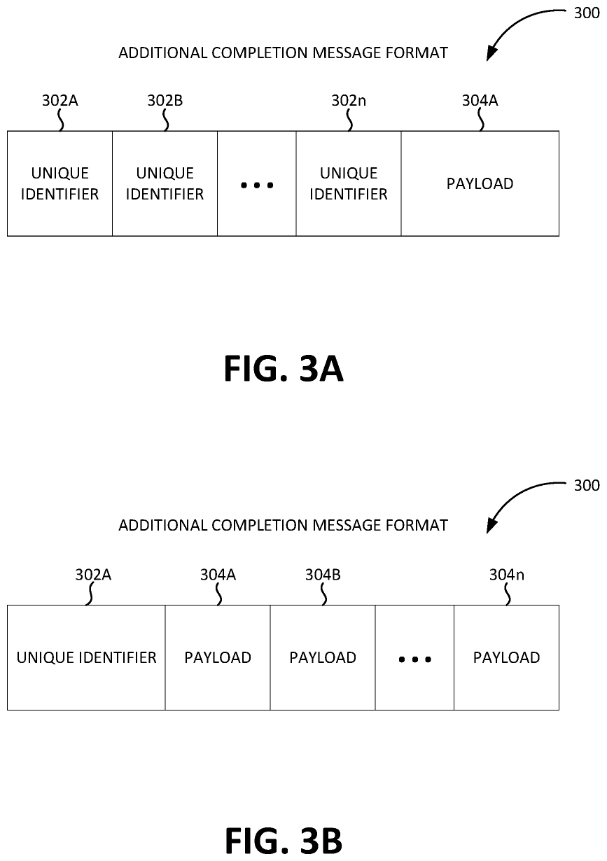

A multiple-completion work descriptor (e.g., multiple-completion work descriptor 200 of FIGS. 2A-C) of work descriptors 108A-n may instruct hardware device 104 to send additional completion message(s) 128 associated with each of hardware triggers 120A-n when each hardware trigger is activated. Additional completion messages 128 may include information related to the hardware trigger (e.g., payloads) such as a timestamp of when the hardware trigger was activated or an operational statistic. Example operational statistics may include a latency statistic associated with the work descriptor (e.g., PCI read latency), a buffer utilization when the hardware trigger is reached (e.g., buffer utilization when sending a packet), a cache hit or miss, a cache read latency, or any other statistic associated with the hardware device, work descriptor, workflow task, hardware event, or hardware trigger. In some embodiments, hardware device 104 may send a completion message associated with a hardware trigger (e.g., hardware trigger 120A) if a conditional evaluation is met (e.g., conditional evaluation 130), and may refrain from sending a completion message if a conditional evaluation is not met. For example, a hardware trigger may be a cache read event, a conditional evaluation may be whether there was a cache hit or miss, and an additional completion message may be sent if there was a cache miss. Example additional completion message formats are described herein with respect to FIGS. 3A-B.

Completion dispatch 124 may be a portion of memory, a buffer, a file, a queue, or other solution for storing and/or sending completion messages to completion endpoint 110. Hardware device 104 may send additional completion messages 128 to host 102 via completion endpoint 110 at the completion of the associated multi-completion work descriptor (e.g., simultaneously with performance completion message 126), at the completion of each workflow task, or at another interval as appropriate. Additional completion messages may be sent individually or may be grouped by event, trigger criterion, workflow task, work descriptor, or other grouping scheme as appropriate. In at least one embodiment, hardware device 104 sends completion messages to host 102 via communication channel 106, such as via direct memory access. In at least one embodiment, hardware device 104 maintains completion messages in a buffer until the completion messages are requested by host 102. In at least one embodiment, hardware device 104 sends completion messages directly to host 102 as they are issued.

In at least one embodiment, hardware device 104 sends completion messages to multiple completion endpoints on host 102 or other devices attached to hardware device 104. Referring to FIG. 1B, hardware device 104 may be attached to a plurality of hosts 102A-B via communication channels 106A-B. For example, host 102B may be an external debugger or storage device attached to a shared PCI bus (communication channels 106A-B in this example). Host 102A may include multiple completion endpoints 110A-B, which may be associated with different applications, drivers, etc. Other devices (e.g., host 102B) may include additional completion endpoints (e.g., completion endpoint 110C). A performance completion message may be sent to one completion endpoint (e.g., completion endpoint 110A), and additional completion messages may be sent to one or more of completion endpoints 110A-C in this example.

FIGS. 2A-C illustrate examples of a multiple-completion work descriptor 200 used for generating additional completion messages with various data payloads in accordance with one or more aspects of the present disclosure. Referring to FIG. 2A, multiple-completion work descriptor 200 includes a standalone work descriptor 202 and accompanying work descriptor type field 204A. In at least one embodiment, standalone work descriptor 202 instructs hardware device 104 to perform one or more workflow tasks comprising one or more hardware events. Accompanying work descriptor type field 204A can inform hardware device 104 about the format or contents of standalone work descriptor 202. Work descriptor type field 204A may be fixed-length (e.g., n bits) or variable-length, and may be encoded as a binary sequence, an integer, a string, or any other data type as appropriate. For example, upon receiving a new work descriptor, hardware device 104 may read the first n bits to determine based on work descriptor type field 204A that the new work descriptor is a send-packet work descriptor. Hardware device 104 may then proceed to read the remainder of standalone work descriptor 202 to determine data storage locations, packet destination addresses, and other information as determined by the expected format associated with work descriptor type field 204A. Standalone work descriptor 202 may encompass a single workflow task (e.g., send data A to address A) or may comprise multiple workflow tasks (e.g., send data A. . . . B to addresses A. . . . B). As described herein with respect to FIG. 1A, each workflow task may initiate one or more hardware events associated with hardware device 104 (e.g., fetch data, attach packet header, send packet).

In at least one embodiment, standalone work descriptor 202 and accompanying work descriptor type field 204A is extended to provide multiple-completion work descriptor 200 described herein. Multiple-completion work descriptor 200 may further include an additional work descriptor type field 204B and additional completion configuration field 206. Additional work descriptor type field 204B may follow the same format as work descriptor type field 204A accompanying standalone work descriptor 202 (e.g., n bits fixed-length), and may include a unique value to inform hardware device 104 that the present work descriptor is an extended multiple-completion work descriptor. In response to receiving a new work descriptor with leading work descriptor type field 204B indicating that the present work descriptor is a multiple-completion work descriptor, hardware device 104 may proceed to read additional completion configuration field 206 and then decode second work descriptor type field 204A and standalone work descriptor 202 as described above to determine the workflow tasks. This multiple-completion work descriptor format is advantageous for the host because existing work descriptors can be converted to multiple-completion work descriptors by prepending additional completion configuration field 206 and additional work descriptor type field 204B, with no need to modify the format or content of the original work descriptors. Furthermore, the same decoding hardware can be utilized on hardware device 104 for decoding both work descriptor type fields 204A-B.

Additional completion configuration field 206 of multiple-completion work descriptor 200 may be used to instruct hardware device 104 to send additional completion messages associated with select hardware triggers as hardware device 104 executes the workflow task(s) of standalone work descriptor 202. Addition completion configuration field 206 may comprise a trigger criteria bitmask 208. Bits 208A-n of the bitmask may each correspond to one or more hardware triggers that may initiate additional completion messages by hardware device 104, and activating a bit in the bitmask (e.g., setting it to 1) may indicate that hardware device 104 should send one or more additional completion messages for the associated hardware trigger(s). The length of trigger criteria bitmask 208 and correspondence between bits and hardware triggers may vary for different standalone work descriptors 202 that have different activated hardware events, or trigger criteria bitmask 208 may be consistent for all work descriptors and encompass all possible hardware triggers. Not all bits may be applicable for a given work descriptor in the latter case. For example, in a copy-data work descriptor, an attach-packet-header event may not be activated, and hardware device 104 may ignore the corresponding trigger criterion bit as a result.

In at least one embodiment, a single bit may correspond to a single hardware trigger and a single payload for the additional completion message. For example, setting a single bit may instruct hardware device 104 to send a completion message comprising a network port buffer utilization statistic in response to a hardware trigger associated with sending a packet through the port. Other bits may designate other payloads associated with the same trigger. Continuing the previous example, another bit may instruct hardware device 104 to send a completion message comprising a timestamp associated with the packet being sent through the same port. Thus, a multiple-completion work descriptor can select different payloads for additional completion messages in various contexts. For example, a multiple-completion work descriptor used for debugging purposes may enable both the timestamp and buffer utilization examples given above, whereas a multiple-completion work descriptor used for routine monitoring of the hardware device resources may enable the buffer utilization payload for the same trigger and not the timestamp payload.

In at least one embodiment, a single bit may correspond to a conditional evaluation of an operational statistic associated with a hardware trigger and may be further associated with a second bit corresponding to the hardware trigger. The combination of the two bits may instruct hardware device 104 to send an additional completion message for the trigger criterion only if the condition is met. For example, a multiple-completion work descriptor may instruct hardware device 104 to send an additional completion message comprising a timestamp when triggered by a cache read (trigger bit), but only if the cache read results in a cache miss (conditional evaluation bit). Another example of a conditional evaluation is a threshold of an operating statistic, such as a buffer utilization exceeding a threshold value. In this example, an additional completion message may be sent only when the threshold value is exceeded.

In at least one embodiment, some bits of trigger criteria bitmask 208 may have compound meaning, inducing hardware device 104 to apply additional logic to determine the additional completion messages and payloads to send. A single bit may correspond to multiple trigger criteria, multiple completion message payloads for a trigger criterion, a trigger criterion with a conditional evaluation, or other combination of configurations for additional completion messages. For example, a bit may correspond to every trigger associated with a network port, such as a trigger for buffering a packet to send, a trigger for initiating transmission of the packet, and a trigger for completing transmission of the packet. As an additional example, a bit may correspond to each payload associated with buffering the packet to send, such as a timestamp and a buffer utilization statistic. Referring to the previous conditional evaluation example, a bit may correspond to a trigger for a cache read event conditional upon the cache read resulting in a cache miss. Other configurations may be combined into a single bit, which may provide multiple levels of granularity for additional-completion work descriptors. Thus, additional-completion work descriptors may be easier to configure in some contexts. For example, a single bit may activate each available trigger criterion and/or payloads for a work descriptor. In some embodiments, some bits may have a negative or modifying effect. For example, while one bit enables each available payload, a second bit may further disable a timestamp payload, thus resulting in completion messages comprising every payload except timestamps.

In at least one embodiment, additional completion configuration field 206 comprises additional fields related to configurating hardware triggers and additional completion messages. For example, an additional field may be used to instruct the hardware device to generate additional completion messages for a subset (rather than all) of workflow tasks associated with standalone work descriptor 202 (e.g., every 10 workflow tasks, first workflow task, last workflow task, etc.), or an additional field may be used to instruct the hardware device to perform identical completion message generation operations for subsequent work descriptors. As an additional example, additional completion configuration field 206 may further specify one or more completion endpoints (e.g., completion endpoints 110A-C of FIG. 1B) to which a subset of additional completion messages should be sent. In a further example, additional completion configuration field 206 may further specify unique identifiers for additional completion messages associated with the work descriptor or a method for generating unique identifiers. Unique identifiers are further described with respect to FIGS. 3A-B below. In a further example, additional completion configuration field 206 may specify additional completion messages to be grouped for dispatch by event, trigger criterion, workflow task, work descriptor, or other grouping scheme as appropriate Additional fields may also comprise additional trigger criteria bitmasks similar to trigger criteria bitmask 208, each bitmask corresponding to a subset of workflow tasks of the work descriptor. In at least one embodiment, additional completion configuration field 206 stores additional completion configurations using a format other than a bitmask. For example, an array or list of fixed- or variable-width configuration options may be used.

Referring to FIG. 2B, the fields of multiple-completion work descriptor 200 may be ordered differently or omitted in embodiments as appropriate in each application. In at least one embodiment, work descriptor type field 204B indicating a multiple-completion work descriptor is immediately followed by second work descriptor type field 204A and accompanying standalone work descriptor 202, with additional completion configuration field 206 appended to the end of multiple-completion work descriptor 200. In at least one embodiment, additional completion configuration field 206 is absent (not shown). Hardware device 104 may default to enabling a subset (e.g., all) of possible trigger criteria and payloads, or the trigger criteria and payloads may be otherwise inherent in the standalone work descriptor. In at least one embodiment, a multiple-completion work descriptor 200 defines additional completion message trigger criteria and payloads to be applied to subsequent work descriptors. Thus, the subsequent work descriptors would not require additional completion configuration field 206 or additional work descriptor type field 204B. In at least one embodiment, multiple-completion work descriptor 200 includes additional fields not depicted in FIGS. 2A-C.

Referring to FIG. 2C, a multiple-completion work descriptor 200 includes a single work descriptor type field 204C in place of work descriptor type fields 204A-B in at least one embodiment. Work descriptor type field 204C may simultaneously indicate the work descriptor type of standalone work descriptor 202 and that the present work descriptor is a multiple-completion work descriptor as well. Thus, there may be up to 2n work descriptor type codes for n work descriptor types (potentially multiple-completion and single-completion versions of each type) in at least one embodiment. Not all work descriptors may correspond to multiple-completion variants in some embodiments.

FIG. 3A-B illustrate example additional completion messages 300 that are sent from hardware device 104 in response to one or more hardware triggers associated with a work descriptor or workflow task in at least one embodiment. Additional completion message 300 may include one or more unique identifier fields (e.g., unique identifier 302A of FIG. 3B or unique identifiers 302A-n of FIG. 3A) and/or one or more payload fields (e.g., payload 304A of FIG. 3A or payloads 304A-n of FIG. 3B). These fields may be encoded and stored as text (e.g., ASCII or UTF-8 encoding), integers, floating-point numbers, binary encoding, or other data type as appropriate for the application.

Unique identifiers 302A-n may be used to associate additional completion message 300 with a work descriptor (e.g., multiple-completion work descriptor 200 of FIG. 2A-C), a workflow task of a work descriptor, a hardware event, a hardware trigger, a local resource of hardware device 104, or other relevant classification. Unique identifiers 302A-n may be used by host 102 to distinguish additional completion messages from each other and associate them with the relevant classifications. Unique identifiers 302A-n may be generated by host system 102 and associated with a classification before queueing multiple-completion work descriptor 200. The generated unique identifiers may be included in the queued work descriptor as previously described with respect to FIG. 2A. Unique identifiers 302A-n may also be generated on-the-fly and later associated with relevant classifications via, e.g., a database, completion endpoint 110, or similar. Unique identifiers 302A-n may be fixed- or variable-length fields of bitmasks, integers, strings, or other data type for encoding the relevant classifications. For example, a hardware trigger unique identifier field may comprise a bitmask with one or more bits set to associate the completion message with one or more hardware triggers. In some embodiments, unique identifiers 302A-n may further identify the type of payload(s) in the completion message.

Payloads 304A-n may be used to send data relevant to additional completion message 300, e.g., as determined by configurations in trigger criteria bitmask 208 and/or additional completion configuration field 206. The data may be debugging information, operational statistics, or other information relevant to operation or development of the system. Payload contents and formats may vary depending on the hardware triggers and payloads configured in the associated multiple-completion work descriptor. An example payload may include a timestamp indicating the time the associated hardware trigger was reached. Another example payload may include a latency statistic associated with the latency of a PCI read or cache read. Another example payload may include a buffer utilization statistic associated with a network port buffer when sending a packet. In a further example, a payload may indicate a binary statistic such as whether a cache access resulted in a cache hit or cache miss. Other examples of operational statistics that may be included in payloads are power consumption, temperature readings, clock speeds, network link speeds, etc. In some embodiments, additional completion messages may be grouped for dispatch by event, trigger criterion, workflow task, work descriptor, or other grouping scheme as appropriate, and thus an additional completion message may comprise a plurality of unique identifiers and payloads that may otherwise be sent in separate additional completion messages.

In at least one embodiment, additional completion message 300 consists of payloads 302A-n (e.g., and not other fields), and the host-side analyst (e.g., human or software) relies on the order in which additional completion messages are received to determine which hardware triggers correspond to each message. A compact additional completion message such as this may be advantageous in situations where workflow tasks and hardware triggers are guaranteed to occur in order, and further where the host-side facilities benefit from reduced message size or smaller bandwidth requirements. Similarly, in at least one embodiment, additional completion message 300 consists of unique identifiers 302A-n (e.g., and not other fields), and the completion message simply indicates that a hardware trigger was reached without providing unneeded data. More generally, additional completion messages may comprise zero or more unique identifier fields, zero or more payload fields, and other fields as needed in each use case in some embodiments. In at least one embodiment, additional completion messages may have a fixed number of fields and/or fixed length for every message, or additional completion messages may have variable numbers of fields and/or variable lengths for different work descriptors, workflow tasks, hardware events, hardware triggers, etc.

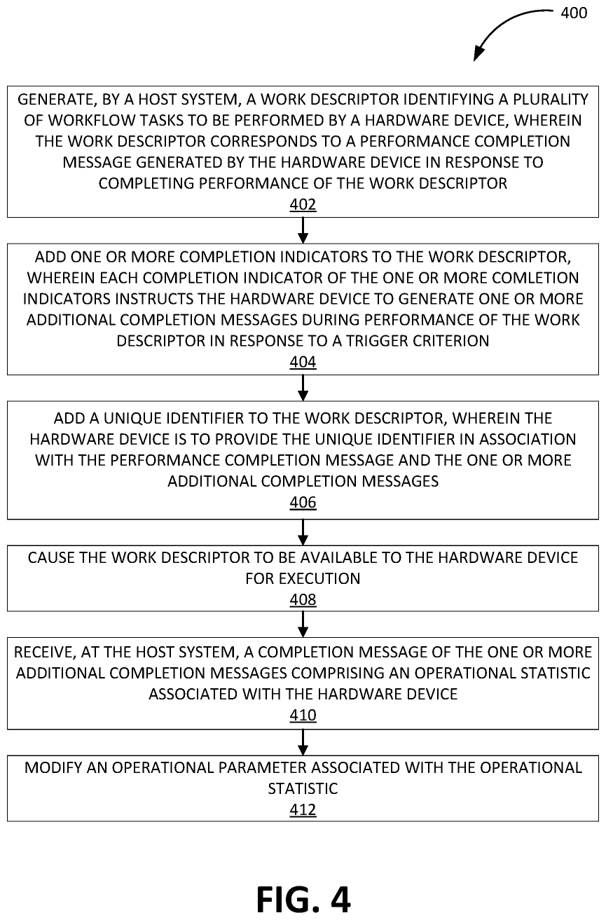

FIG. 4 depicts a flow diagram of an example method 400 for providing additional completion messages in response to hardware triggers using multiple-completion work descriptors, in accordance with one or more aspects of the present disclosure. The method may be performed by processing logic that may comprise hardware (circuitry, dedicated logic, etc.), computer readable instructions such as software or firmware (run on a general-purpose computing system or a dedicated machine), or a combination of both. In an illustrative example, method 400 may be performed by computer system 600 of FIG. 6. Alternatively, some or all of method 400 might be performed by another module or machine. In at least one embodiment, method 400 is performed by host 102 or components thereof (e.g., OS 112 or application 114). It should be noted that blocks depicted in FIG. 4 could be performed simultaneously or in a different order than that depicted. Embodiments may include additional blocks not depicted in FIG. 4 or a subset of blocks depicted in FIG. 4.

At block 402, processing logic of a host system generates a work descriptor identifying a plurality of workflow tasks to be performed by a hardware device. The host system is host 102 in at least one embodiment, and the work descriptor may be generated by application 114, OS 112, or some other component in communication with host 102. In at least one embodiment, the work descriptor is standalone work descriptor 202 with accompanying work descriptor type field 204A of FIGS. 2A-B. The host system may generate the work descriptor by determining the type of workflow tasks desired, setting an appropriate work descriptor type field, and then specifying one or more workflow tasks of that type to comprise the full work descriptor. In at least one embodiment, the workflow tasks may be of different types. The hardware device is hardware device 104 of FIG. 1A-B in at least one embodiment. For example, the hardware device may be one of a network interface controller, a graphics processing unit, a data processing unit, or a central processing unit.

In at least one embodiment, the work descriptor corresponds to a performance completion message generated by the hardware device in response to completing performance of the work descriptor. The performance completion message may be sent to or received by the hosts system at a completion endpoint, such as completion endpoint 110 of FIG. 1A. The performance completion message may indicate to the host system that one or more workflow tasks of the work descriptor and/or the work descriptor itself have been completed. In at least one embodiment, the performance completion message may include one or more fields, such as unique identifier fields or payload fields (e.g., as described with respect to additional completion message 300 of FIG. 3).

At block 404, the processing logic adds one or more completion indicators to the work descriptor. Each completion indicator of the one or more completion indicators may instruct the hardware device to generate one or more additional completion messages during performance of the work descriptor in response to a trigger criterion. As described with respect to FIG. 1A, the trigger criterion may comprise or may be associated with a hardware event, a resource of the hardware device, an event associated with a workflow task of the plurality of workflow tasks, or other relevant hardware trigger or combination thereof. For example, a trigger criterion may indicate an initiation, completion, or an error status of a hardware event in relation to a workflow task. In at least one embodiment, the trigger criterion may further comprise a conditional evaluation of an operational statistic. Example operational statistics may include latencies, utilizations, timestamps, bandwidths, power and other resource consumption, etc. In at least one embodiment, a completion message of the one or more completion messages comprises an operating statistic (e.g., as a payload), which may be at least one of a timestamp, a latency statistic, or a utilization statistic.

In at least one embodiment, adding the one or more completion indicators to the work descriptor further comprises generating a wrapper work descriptor comprising the work descriptor and a completion indicator field. The wrapper work descriptor may be multiple-completion work descriptor 200 of FIGS. 2A-C comprising standalone work descriptor 202 and additional completion configuration field 206. The wrapper work descriptor may include other fields, such as work descriptor type fields 204A-C where appropriate. In at least one embodiment, the completion indicator field comprises a plurality of bits corresponding to a plurality of supported completion indicators (e.g., trigger criteria bitmask 208). Adding the one or more completion indicators to the work descriptor may further comprise setting one or more bits of the plurality of bits corresponding to the one or more completion indicators. In at least one embodiment, the completion indicator field may be other data types or data fields added to the work descriptor.

At block 406, the processing logic adds a unique identifier to the work descriptor. In at least one embodiment, the hardware device is to provide the unique identifier in association with the performance completion message and/or the one or more additional completion messages (e.g., unique identifiers 302A-n of FIG. 3A-B). The unique identifier may associate the corresponding completion message(s) with specific work descriptors, workflow tasks, hardware events, trigger criteria, or other classifications as appropriate. In at least one embodiment, the host may instruct the hardware device to generate one or more unique identifiers, e.g., by setting one or more appropriate configurations in the work descriptor.

At block 408, the processing logic causes the work descriptor to be available to the hardware device for execution. In at least one embodiment, causing the work descriptor to be available to the hardware device for execution further comprises storing the work descriptor in a work queue of the host system and notifying the hardware device about the work descriptor in the work queue. The work queue of the host system may be work descriptor queue 107, for example. The processing logic may store the work descriptor in the queue by calling a function or API (e.g., associated with driver or library), writing to a section of memory or memory-mapped I/O (e.g., using direct memory access), sending a message via a network interface or message-passing system, or similar technique. Likewise, the work queue may be accessible to the hardware device using these or other techniques (e.g., via communication channel 106). The processing logic may use any of the techniques described herein or similar techniques to notify the hardware device in at least one embodiment (e.g., using an API, communicating via communication channel 106). In at least one embodiment, the hardware device may self-notify by observing changes to the contents of the work queue, thus not requiring additional action from the processing logic to notify the hardware device after storing the work descriptor in the work queue. The hardware device may access the work descriptor in the work queue upon receiving a notification.

At block 410, the processing logic receives, at the host system, a completion message of the one or more additional completion messages comprising an operational statistic associated with the hardware device. In at least one embodiment, the completion message is one of additional completion messages 128 and may be received from the hardware device using completion endpoint 110 or other techniques described with respect to FIGS. 1A-B herein. The operation statistic associated with the hardware device may be a latency statistic (e.g., cache read or PCI read latency); a utilization statistic (e.g., buffer or memory utilization); an error, exception, or conditional event (e.g., a cache miss or packet send error rate), other information relevant to the operation or development of the hardware device. The operational statistic may be a be a payload of the completion message (e.g., one of payloads 304A-n of FIGS. 3A-B). In at least one embodiment, the completion message received from hardware device may comprise a plurality of operational statistics consolidated in a single completion message based on the work descriptor, workflow task, event, trigger, or other grouping scheme.

At block 412, the processing logic modifies an operational parameter associated with the operational statistic. In at least one embodiment, the operational parameter may be an operational parameter of the host system, such a resource allocation or a parameter associated with the work descriptor. For example, the operational parameter may be a bandwidth allocation associated with a PCI link or DMA controller available to the hardware device, and upon receiving an operational statistic indicating excessive PCI latency experienced by the hardware device, the host system may reduce its bandwidth allocation to free more bandwidth for the hardware device. In another example, the operational parameter may be a rate at which the host device enqueues new work descriptors for the hardware device, and upon receiving an operational statistic indicating excessive buffer utilization on the hardware device, the host system may reduce the rate at which new work descriptors are enqueued. In at least one embodiment, the operational parameter may be an operational parameter of the hardware device, such as a resource allocation or a hardware setting. For example, upon receiving an operational statistic indicating excessive buffer utilization on the hardware device, the host system may instruct the hardware device to increase its memory allocation for the buffer and/or increase its clock speed to process the buffer faster. Various other operational parameters on the host system and/or hardware device may be modified in response to various operational statistics.

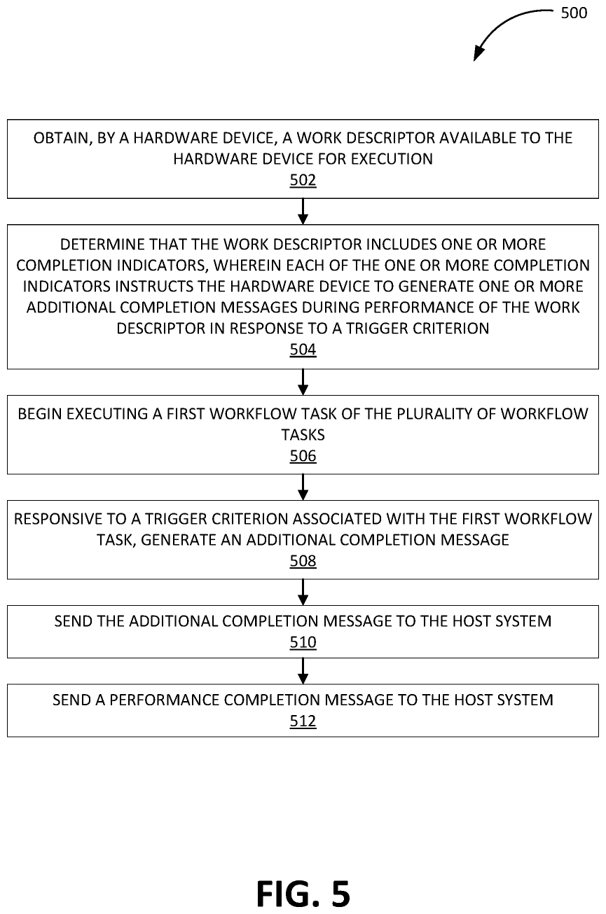

FIG. 5 depicts a flow diagram of an example method 500 for providing additional completion messages in response to hardware triggers using multiple-completion work descriptors, in accordance with one or more aspects of the present disclosure. The method may be performed by processing logic that may comprise hardware (circuitry, dedicated logic, etc.), computer readable instructions such as software or firmware (run on a general-purpose computing system or a dedicated machine), or a combination of both. In an illustrative example, method 500 may be performed by computer system 600 of FIG. 6. Alternatively, some or all of method 500 might be performed by another module or machine. In at least one embodiment, method 500 is performed by hardware device 104 or components thereof (e.g., work descriptor execution engine 118). It should be noted that blocks depicted in FIG. 5 could be performed simultaneously or in a different order than that depicted. Embodiments may include additional blocks not depicted in FIG. 5 or a subset of blocks depicted in FIG. 5.

At block 502, processing logic of a hardware device obtains a work descriptor available to the hardware device for execution. The work descriptor may comprise a one or more workflow tasks, such as described with respect to standalone work descriptor 202 of FIGS. 2A-C. In at least one embodiment, obtaining the work descriptor may comprise receiving a notification from a host system of a work descriptor available for processing and fetching the work descriptor from a work queue of the host system. The host system may be host 102, and the hardware device may be hardware device 104. The work queue may be work descriptor queue 107. The notification may be transmitted as described with respect to FIG. 4. The work descriptor may be fetched via communication channel 106 using direct memory access, a function or API call, a network interface, a message-passing system, or similar technique. In at least one embodiment, obtaining the work descriptor may comprise polling the host (e.g., a work queue or memory location of the host) for new work descriptors and receiving a new work descriptor from the host. Other procedures for obtaining a work descriptor may be used in other embodiments.

At block 504, the processing logic determines that the work descriptor includes one or more completion indicators. Each of the one or more completion indicators may correspond to one or more workflow tasks of the work descriptor and may instruct the hardware device to generate one or more additional completion messages during performance of the work descriptor in response to a trigger criterion. In at least one embodiment, the processing logic decodes a work descriptor type field (e.g., work descriptor type field 204B or 204C) to determine that the work descriptor includes one or more completion indicators. Each completion indicator may correspond to a workflow task, a hardware event, a trigger criterion, or other aspect of the hardware device as described herein with respect to FIG. 2. In at least one embodiment, the determining may be done by work descriptor execution engine 118.

At block 506, the processing logic begins executing a first workflow task of the workflow tasks of the work descriptor. In at least one embodiment, work descriptor execution engine 118 begins executing the first workflow task.

At block 508, the processing logic, responsive to a trigger criterion associated with the first workflow task, generates an additional completion message. In at least one embodiment, trigger criterion associated with the first workflow task may be one of hardware triggers 110A-n. In at least one embodiment, generating the additional completion message may be further responsive to evaluating a conditional evaluation associated with the trigger criterion (e.g., conditional evaluation 130). The additional completion message may be additional completion message 300 of FIGS. 3A-B and may comprise one or more unique identifiers and one or more payloads as described herein.

At block 510, the processing logic sends the additional completion message to the host system. The additional completion message may be sent to the host system using completion endpoint 110 or other techniques described with respect to FIGS. 1A-B herein. In at least one embodiment, the additional completion message may be merged or grouped with other additional completion messages for sending.

At block 512, the processing logic sends a performance completion message to the host system. The performance completion message may be sent to the host system using completion endpoint 110 or other techniques described with respect to FIGS. 1A-B herein. In at least one embodiment, the performance completion message may be merged or grouped with one or more additional completion messages for sending.

FIG. 6 is a block diagram illustrating an example computer system 600 in accordance with at least some embodiments. In at least one embodiment, computer system 600 may be a system with interconnected devices and components, a System on Chip (SoC), or some combination. In at least one embodiment, computer system 600 is formed with a processor 602 that may include execution units to execute an instruction. In at least one embodiment, computer system 600 may include, without limitation, a component, such as a processor 602, to employ execution units including logic to perform algorithms for processing data. In at least one embodiment, computer system 600 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS' operating system available from Microsoft Corporation of Redmond, Wash., although other operating systems (UNIX and Linux, for example), embedded software, and/or graphical user interfaces, may also be used.

In at least one embodiment, computer system 600 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 600 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 600 may include, without limitation, processor 602 that may include, without limitation, one or more execution units 608 that may be configured to process traceable work descriptors and/or perform on-demand hardware event logging according to techniques described herein. In at least one embodiment, computer system 600 is a single processor desktop or server system. In at least one embodiment, computer system 600 may be a multiprocessor system. In at least one embodiment, processor 602 may include, without limitation, a complex instruction set computer (CISC) microprocessor, a reduced instruction set computer (RISC) microprocessor, a Very Long Instruction Word (VLIW) microprocessor, and a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. In at least one embodiment, processor 602 may also include a combination of both internal and external caches. In at least one embodiment, a register file 606 may store different types of data in various registers, including integer registers, floating point registers, status registers, instruction pointer registers, or the like.

In at least one embodiment, execution unit 608, including, without limitation, logic to perform integer and floating-point operations, also resides in processor 602. Processor 602 may also include a microcode (“ucode”) read-only memory (“ROM”) that stores microcode for certain macro instructions. In at least one embodiment, execution unit 608 may include logic to handle a packed instruction set 609. In at least one embodiment, by including packed instruction set 609 in an instruction set of a general-purpose processor 602, along with associated circuitry to execute instructions, operations used by many multimedia applications may be performed using packed data in a general-purpose processor 602. In at least one embodiment, many multimedia applications may be accelerated and executed more efficiently by using the full width of a processor's data bus for performing operations on packed data, which may eliminate the need to transfer smaller units of data across a processor's data bus to perform one or more operations one data element at a time.

In at least one embodiment, execution unit 608 may also be used in microcontrollers, embedded processors, graphics devices, DSPs, and other types of logic circuits. In at least one embodiment, computer system 600 may include, without limitation, a memory 620. In at least one embodiment, memory 620 may be implemented as a Dynamic Random Access Memory (DRAM) device, a Static Random Access Memory (SRAM) device, a flash memory device, or other memory devices. Memory 620 may store instruction(s) 619 and/or data 621 represented by data signals that may be executed by processor 602.

In at least one embodiment, a system logic chip may be coupled to a processor bus 610 and memory 620. In at least one embodiment, the system logic chip may include, without limitation, a memory controller hub (“MCH”) 616, and processor 602 may communicate with MCH 616 via processor bus 610. In at least one embodiment, MCH 616 may provide a high bandwidth memory path to memory 620 for instruction and data storage and for storage of graphics commands, data, and textures. In at least one embodiment, MCH 616 may direct data signals between processor 602, memory 620, and other components in computer system 600 and may bridge data signals between processor bus 610, memory 620, and a system I/O 622. In at least one embodiment, a system logic chip may provide a graphics port for coupling to a graphics controller. In at least one embodiment, MCH 616 may be coupled to memory 620 through high bandwidth memory path, and graphics/video card 612 may be coupled to MCH 616 through an Accelerated Graphics Port (“AGP”) interconnect 614.

In at least one embodiment, computer system 600 may use system I/O 622, which can be a proprietary hub interface bus to couple MCH 616 to I/O controller hub (“ICH”) 630. In at least one embodiment, ICH 630 may provide direct connections to some I/O devices via a local I/O bus. In at least one embodiment, a local I/O bus may include, without limitation, a high-speed I/O bus for connecting peripherals to memory 620, a chipset, and processor 602. Examples may include, without limitation, an audio controller 629, a firmware hub (“flash BIOS”) 628, a wireless transceiver 626, a data storage 624, a legacy I/O controller 623 containing a user input interface 625, a keyboard interface, a serial expansion port 627, such as a USB port, and a network controller 634, which may include in some embodiments, a data processing unit. Data storage 624 may comprise a hard disk drive, a floppy disk drive, a CD-ROM device, a flash memory device, or other mass storage devices.

In at least one embodiment, FIG. 6 illustrates a computer system 600, which includes interconnected hardware devices or “chips.” In at least one embodiment, FIG. 6 may illustrate an example SoC. In at least one embodiment, devices illustrated in FIG. 6 may be interconnected with proprietary interconnects, standardized interconnects (e.g., Peripheral Component Interconnect Express (PCIe), or some combination thereof. In at least one embodiment, one or more components of computer system 600 are interconnected using compute express link (“CXL”) interconnects.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more individual non-transitory storage media of multiple non-transitory computer-readable storage media lacks all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples or exemplary language (e.g., “such as”) provided herein is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulates and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As a non-limiting example, a “processor” may be a network device. A “computing platform” may comprise one or more processors. As used herein, “software” processes may include, for example, software and/or hardware entities that perform work over time, such as tasks, threads, and intelligent agents. Also, each process may refer to multiple processes for continuously or intermittently carrying out instructions in sequence or parallel. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
generating, by a host system, a work descriptor identifying a plurality of workflow tasks to be performed by a hardware device, wherein the work descriptor corresponds to a performance completion message generated by the hardware device in response to completing performance of the work descriptor;
adding one or more completion indicators to the work descriptor, wherein each completion indicator of the one or more completion indicators instructs the hardware device to generate one or more additional completion messages during performance of the work descriptor in response to a trigger criterion; and
causing the work descriptor to be available to the hardware device for execution.

2. The method of claim 1, further comprising adding a unique identifier to the work descriptor, wherein the hardware device is to provide the unique identifier in association with the performance completion message and the one or more additional completion messages.

3. The method of claim 1, further comprising:
receiving, at the host system, a completion message of the one or more additional completion messages comprising an operational statistic associated with the hardware device; and
modifying an operational parameter associated with the operational statistic.

4. The method of claim 1, wherein the hardware device is one of: a network interface controller, a graphics processing unit, a data processing unit, or a central processing unit.

5. The method of claim 1, wherein adding the one or more completion indicators to the work descriptor further comprises generating a wrapper work descriptor comprising the work descriptor and a completion indicator field.

6. The method of claim 5, wherein the completion indicator field comprises a plurality of bits corresponding to a plurality of supported completion indicators, and wherein adding the one or more completion indicators to the work descriptor further comprises setting one or more bits of the plurality of bits corresponding to the one or more completion indicators.

7. The method of claim 1, wherein a completion message of the one or more additional completion messages comprises at least one of: a timestamp, a latency statistic, or a utilization statistic.

8. The method of claim 1, wherein the trigger criterion comprises an event associated with a workflow task of the plurality of workflow tasks.

9. The method of claim 8, wherein the trigger criterion further comprises a conditional evaluation of an operational statistic.

10. The method of claim 1, wherein causing the work descriptor to be available to the hardware device for execution further comprises:
storing the work descriptor in a work queue of the host system, wherein the work queue is accessible by the hardware device; and
notifying the hardware device about the work descriptor in the work queue.

11. A system comprising:
a memory; and
one or more processing units coupled to the memory, the one or more processing units to:
generate a work descriptor identifying a plurality of workflow tasks to be performed by a hardware device, wherein the work descriptor corresponds to a performance completion message generated by the hardware device in response to completing performance of the work descriptor;
add one or more completion indicators to the work descriptor, wherein each completion indicator of the one or more completion indicators instructs the hardware device to generate one or more additional completion messages during performance of the work descriptor in response to a trigger criterion; and
cause the work descriptor to be available to the hardware device for execution.

12. The system of claim 11, the one or more processing units further to add a unique identifier to the work descriptor, wherein the hardware device is to provide the unique identifier in association with the performance completion message and the one or more additional completion messages.

13. The system of claim 11, the one or more processing units further to:
receive a completion message of the one or more additional completion messages comprising an operational statistic associated with the hardware device; and
modify an operational parameter associated with the operational statistic.

14. The system of claim 11, wherein to add the one or more completion indicators to the work descriptor further comprises generating a wrapper work descriptor comprising the work descriptor and a completion indicator field.

15. The system of claim 14, wherein the completion indicator field comprises a plurality of bits corresponding to a plurality of supported completion indicators, and wherein to add the one or more completion indicators to the work descriptor further comprises setting one or more bits of the plurality of bits corresponding to the one or more completion indicators.

16. A non-transitory computer-readable storage medium comprising instructions that, when executed by a processing device, cause the processing device to perform operations comprising:
generating a work descriptor identifying a plurality of workflow tasks to be performed by a hardware device, wherein the work descriptor corresponds to a performance completion message generated by the hardware device in response to completing performance of the work descriptor;
adding one or more completion indicators to the work descriptor, wherein each completion indicator of the one or more completion indicators instructs the hardware device to generate one or more additional completion messages during performance of the work descriptor in response to a trigger criterion; and
causing the work descriptor to be available to the hardware device for execution.

17. The non-transitory computer-readable storage medium of claim 16, wherein the hardware device is one of: a network interface controller, a graphics processing unit, a data processing unit, or a central processing unit.

18. The non-transitory computer-readable storage medium of claim 16, wherein a completion message of the one or more additional completion messages comprises at least one of: a timestamp, a latency statistic, or a utilization statistic.

19. The non-transitory computer-readable storage medium of claim 16, wherein the trigger criterion comprises an event associated with a workflow task of the plurality of workflow tasks.

20. The non-transitory computer-readable storage medium of claim 16, wherein causing the work descriptor to be available to the hardware device for execution further comprises:
storing the work descriptor in a work queue of a host system, wherein the work queue is accessible by the hardware device; and
notifying the hardware device about the work descriptor in the work queue.
